(19) United States
(12) Patent Application Publication
(10) Pub. No.: US 2009/0284375 A1
(43) Pub. Date: Nov. 19, 2009

(54) UHF RFID TAG

(76) Inventors: Yen Nan Kuo, Taipei (TW); Kao Hsiang Wu, Taipei (TW)

Correspondence Address: SINORICA, LLC, 2275 Research Blvd., Suite 500, ROCKVILLE, MD, 20850, US

(21) Appl. No.: 12/176,497

(22) Filed: Jul. 21, 2008

(30) Foreign Application Priority Data
May 16, 2008 (TW) 097118246
May 30, 2008 (TW) 097120241

(51) Int. Cl. G08B 13/22

(52) U.S. Cl. 340/572.1

(57) ABSTRACT

A UHF RFID tag can solve the conventional tag-reading problem occurring when an RFID tag is attached to a metallic or liquid object. The UHF RFID tag comprises: a tag, a foamed layer, and a magnetic layer. The foamed layer is a foamed polymeric material having a density of 10-100 kg/m³ and a permittivity of 1-1.5. The foamed layer is joined to the tag. The magnetic layer is joined to another side of the foamed layer, has a magnetic permeability of 2-10 and a thickness of 0.1-3 mm, and consists of a magnetic powder and a rubber/plastic material, wherein the magnetic powder has a weight percent of 65-95%; the rubber/plastic material has a weight percent of 5-35%; the particles of the magnetic powder have a shape of a platelet, lens or spheroid. The magnetic layer/foamed layer may be a single-layer structure, a multi-layer structure, or a single-layer structure having a gradient density.

### BACKGROUND OF THE INVENTION

1. Field of the Invention

The present invention relates to a RFID tag, particularly to an RFID tag, which is an RFID tag working in a UHF frequency band, and which can solve the conventional tag-reading problem occurring when an RFID tag is attached to a metallic or liquid object.

2. Description of the Related Art

The radio frequency identification (RFID for abbreviation thereinafter) system is a technology using a radio frequency to automatically identify objects and acquire related data. RFID technology was developed to replace the traditional barcode. RFID technology can uniquely label each of the objects, can read data from and write data into the RFID tags of the objects, and can instantly acquire related information of the objects. In addition to fabrication, logistics, warehousing, and retailing, RFID technology also widely applies to daily living activities, such as security, convenience stores, libraries, public transit, parking tolling, electronic freeway tolling, and medical service. RFID technology is still expanding its application field to bring people safer and easier living.

An RFID system comprises a reader/writer, tags, and an application software. The reader/writer sends out an electromagnetic wave or a magnetic field. The tag receives the electromagnetic wave or magnetic field and converts it into electric power to drive the chip inside the tag. The chip sends a wireless signal containing the identification code to the reader/writer. The reader/writer decodes the wireless signal and sends the decoded signal to the rear-end application software. RFID technology is characterized in the automatic and non-contact identification process, wherein the data exchange between the tag and the reader/writer is realized wirelessly.

According to the frequency bands where RFID systems work, RFID systems may be categorized into the low-frequency type (135 KHz), the high-frequency type (13.56 MHz), the ultra-high-frequency (UHF) type (860-96 OMHz) and the microwave type (2.45 GHz). Table 1 shows the frequency ranges and transmission methods of RFID systems.

TABLE 1
Frequency Ranges and Transmission Methods of RFID Systems

| | Frequency | | Frequency Used | | Coupling |
|---|---|---|---|---|---|
| | Range | | by RFID | | Method |
| Low | 30-300 | KHz | 125-135 | KHz | Electromagnetic |
| Frequency | | | | | Induction |
| High | 3-30 | MHz | 13.56 | MHz | Electromagnetic |
| Frequency | | | | | Induction |
| Ultra High | 300-1000 | MHz | 915 | MHz | Electromagnetic |
| Frequency | | | | | Wave Coupling |
| Microwave | Over 1 | GHz | 2.45 | GHz | Electromagnetic |
| | | | | | Wave Coupling |

The frequency bands of 135 KHz and 13.56 MHz are most frequently used by RFID systems. However, the RFID systems using the abovementioned frequency bands are disadvantaged by a limited transmission distance between the tag and the reader/writer. Extending the frequency band to the UHF or microwave range is a logical approach to achieve a longer transmission distance and a higher transmission rate. For example, an RFID system using a UHF frequency band (860-960 MHz) can have a transmission distance of over 5 m and a transmission rate of over 40 packets per second.

An RFID tag does not transmit information unless its antenna receives the electromagnetic wave sent out by a reader/writer. An RFID signal is likely to retarded by metallic material or interfered with by noise. The induced current in a metallic material will attenuate the electromagnetic field, shorten the read distance, or even interrupt the communication between the tag and the reader/writer. Thus is reduced the identification capability and correctness of an RFID system. The higher the frequency of an electromagnetic wave, the greater the influence of metals. However, metallic materials are often used in electric appliances and food packages, which RFID systems are usually applied to. Besides, water is also an important factor affecting the sensitivity of an RFID system. Water is likely to reduce the receiving capability of an RFID system. The higher the frequency of an electromagnetic wave, the more the electromagnetic energy absorbed by water.

The antenna of RFID systems is intrinsically apt to be influenced by the environment. The common solution is to vary the design of antenna or adopt an active RFID tag. However, both the abovementioned solutions raise the fabrication cost. Some manufacturers, such as TDK, DIADO, NITTA, EMERSON & CUMING, improve electromagnetic wave absorber materials to solve the influences of metallic or liquid factors. Most of the electromagnetic wave absorber materials only function for the electromagnetic wave below 13.56 MHz. For the influence in the UHF frequency, the solution of some manufacturers is redesigning the antenna, such as the UHF antenna of Mitsubishi, Toppan, and Fujitsu.

For example, a U.S. patent of U.S. Pat. No. 7,205,898 adopts an electromagnetic wave absorption approach to improve the read distance of an RFID system. The prior art adopts a multi-layer electromagnetic wave absorber material emphasizing the magnetic permeability and dielectric permittivity thereof, wherein a first layer contacting the RFID tag adopts a titanium dioxide material, and a second layer adopts a magnetic powder consisting of iron carbonyl, nickel zinc ferrite and magnet and having a magnetic permeability of 1.5-1.7 and a dielectric permittivity of 1.5-32.

At present, most of the RFID systems are still hard to apply to a metallic object or a container containing a water-based liquid. Few of the products can do it, but they overcome the problem via redesigning the antenna or adopting a thicker electromagnetic wave absorber material, which increases the cost. Therefore, the present invention proposes an effective and low-cost electromagnetic wave absorber material to overcome the problem of RFID technology.

### SUMMARY OF THE INVENTION

The primary objective of the present invention is to provide a UHF RFID tag, wherein a foamed layer and a magnetic layer are arranged in between a tag and a metallic/non-metallic layer and function as an electromagnetic wave absorber material to prevent from environmental interference on the reader/writer.

Another objective of the present invention is to provide a UHF RFID tag, which is an RFID tag working in a UHF frequency band, and which can solve the conventional tag-reading problem occurring when an RFID tag is attached to a metallic or liquid object.

The present invention proposes a UHF RFID tag, which comprises: a tag, a foamed layer, and a magnetic layer. The foamed layer is a foamed polymeric material having a density of 10-100 kg/m³ and a permittivity of 1-1.5. The foamed layer may be a single-layer structure, a multi-layer structure, or a single-layer structure having a gradient density. The foamed layer contacts the tag.

The magnetic layer may be a single-layer structure, a multi-layer structure, or a single-layer structure having a gradient density of magnetic powder. The magnetic layer contacts another side of the foamed layer. The magnetic layer has a magnetic permeability of 2-10. The magnetic layer consists of a magnetic powder and a rubber/plastic material, wherein the magnetic powder has a weight percent of 65-95%, and the rubber/plastic material has a weight percent of 5-35%. The magnetic powder has a thickness of 0.1-3 mm, and the particles of the magnetic layer have a shape of a platelet, a lens or a spheroid.

When a metallic or non-metallic layer interferes with the signal of an RFID tag, the foamed layer and magnetic layer of the present invention can make the RFID reader has a longer read distance.

Below, the embodiments are described in detail in cooperation with the attached drawings to make easily understood the objectives, technical contents, characteristics and accomplishments of the present invention.

### BRIEF DESCRIPTION OF THE DRAWINGS

FIG. 1 is a diagram schematically showing the application of a UHF RFID tag according to one embodiment of the present invention;

FIG. 2 is a diagram schematically showing the structure of a UHF RFID tag according to one embodiment of the present invention;

FIG. 3 is a diagram schematically showing the structure of a UHF RFID tag according to another embodiment of the present invention;

FIG. 4 is a diagram schematically showing the structure of a UHF RFID tag according to a further embodiment of the present invention; and

FIG. 5 is a diagram schematically showing UHF RFID tags according to the present invention.

### DETAILED DESCRIPTION OF THE INVENTION

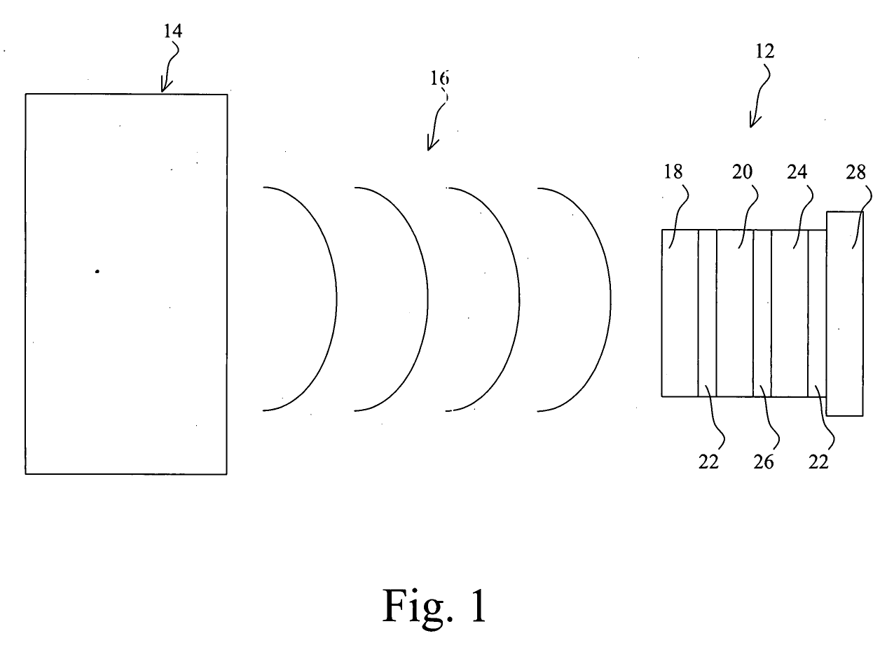

The present invention proposes a UHF RFID tag, which is an RFID tag working in a UHF frequency band, and which can solve the conventional tag-reading problem occurring when an RFID tag is attached to a metallic or liquid object. Refer to FIG. 1. The UHF RFID tag 12 of the present invention is to be read by a reader/writer 14 of an existing RFID system. The reader/writer 14 sends out an electromagnetic wave 16 or a magnetic field 16, which is received by the antenna or induction coil of the UHF RFID tag 12 and therein converted into a power to drive a chip to transmit an identification code to the reader/writer 14.

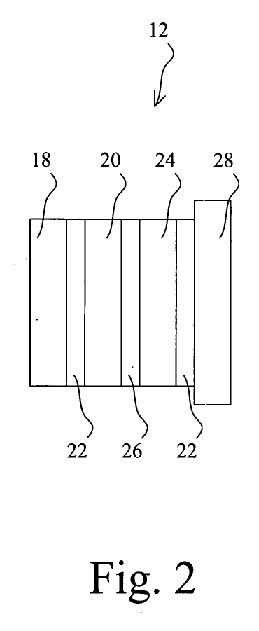

Refer to FIG. 2. The UHF RFID tag 12 of the present invention comprises: a tag 18, a foamed layer 20, and a magnetic layer 24. The foamed layer 20 is arranged in between the tag 18 and the magnetic layer 24. The tag 18 is joined to one surface of the foamed layer 20 with a double-sided adhesive tape 22. The other surface of the foamed layer 20 is joined to one surface of the magnetic layer 24 with a glue 26. The other surface of the magnetic layer 24 is joined to a metallic/non-metallic layer 28 with the double-sided adhesive tape 22.

In this embodiment, the foamed layer 20 is made of a foamed polymeric material having a density of 10-100 kg/m³ and a permittivity of 1-1.5. The polymeric material is selected from the group consisting of a foamed PE/EVA (Polyethylene/Ethylene Vinyl Acetate) board, a foamed CR/EPDM/NBR (Chloroprene Rubber/Ethylene Propylene Diene Monomer/Nitrile Butadiene Rubber) board, a foamed PS (Polystyrene) board, a foamed rubberplastic board, a foamed conductive board, and a foamed anti-electrostatic board. The polymeric material may also be a combination of the abovementioned materials.

In this embodiment, the magnetic layer 24 consists of a magnetic powder and a rubber/plastic material. The magnetic layer 24 has a magnetic permeability of 2-10. The magnetic powder has a weight percent of 65-95%, and the rubber/plastic material has a weight percent of 5-35%. The magnetic layer is made of an iron powder, a cobalt powder, a nickel powder or a powder of an alloy containing the abovementioned metals. The magnetic powder has a thickness of 0.1-3 mm. In the present invention, the particles of the magnetic powder have a shape of a platelet, a lens or a spheroid. In this embodiment, the particles of the magnetic powder have a shape of a platelet. The platelet particles of the magnetic powder have a diameter of 5-35 μm and a thickness of 0.05-0.25 μm. In the present invention, each of the abovementioned foamed layer and magnetic layer has at least one layer. In the abovementioned embodiment, the foamed layer and magnetic layer are both single-layer structures. In the present invention, both the foamed layer and magnetic layer may be multi-layer structures. In other words, the foamed layer 20 has several foamed layers, and the magnetic layer 24 has several magnetic layers.

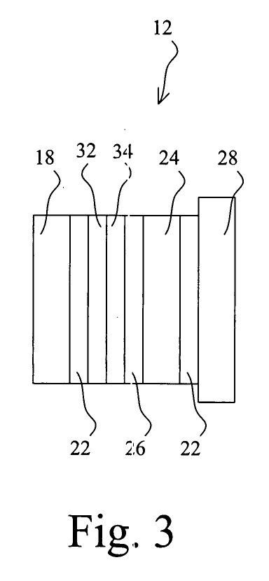

Refer to FIG. 3. In another embodiment, the foamed layer 20 has a first foamed layer 32 and a second foamed layer 34. In this embodiment, the UHF RFID tag 12 of the present invention comprises: a tag 18, a first foamed layer 32, a second foamed layer 34, and a magnetic layer 24. The first foamed layer 32 and the second foamed layer 34 are arranged in between the tag 18 and the magnetic layer 24. The first foamed layer 32 and the second foamed layer 34 are joined together with a glue 26. The tag 18 is joined to the first foamed layer 32 with a double-sided adhesive tape 22. The second foamed layer 34 is joined to the magnetic layer 24 with the glue 26. A metallic/non-metallic layer 28 is arranged in the other side of the magnetic layer 24, and the magnetic layer 24 is joined to the metallic/non-metallic layer 28 with the double-sided adhesive tape 22.

In this embodiment, both the first foamed layer 32 and the second foamed layer 34 are made of a foamed polymeric material. The first foamed layer 32 has a permittivity of 1-1.1 or 1-1.2, and the second foamed layer 34 has a permittivity of 1-1.5. The first foamed layer 32 has a density of 10-50 kg/m³, and the second foamed layer 34 has a density of 50-100 kg/m³. The polymeric material is selected from the group consisting of a foamed PE/EVA (Polyethylene/Ethylene Vinyl Acetate) board, a foamed CR/EPDM/NBR (Chloroprene Rubber/Ethylene Propylene Diene Monomer/Nitrile Butadiene Rubber) board, a foamed PS (Polystyrene) board, a foamed rubberplastic board, a foamed conductive board, and a foamed anti-electrostatic board. The polymeric material may also be a combination of the abovementioned materials.

In this embodiment, the magnetic layer 24 consists of a magnetic powder and a rubber/plastic material. The magnetic layer 24 has a magnetic permeability of 2-10. The magnetic powder has a weight percent of 65-95%, and the rubber/plastic material has a weight percent of 5-35%. The magnetic powder is made of an iron powder, a cobalt powder, a nickel powder or a powder of an alloy containing the abovementioned metals. The magnetic layer has a thickness of 0.1-3 mm. In the present invention, the particles of the magnetic powder have a shape of a platelet, a lens or a spheroid. In this embodiment, the particles of the magnetic powder have a shape of a platelet. The platelet particles of the magnetic powder have a diameter of 5-35 μm and a thickness of 0.05-0.25 μm.

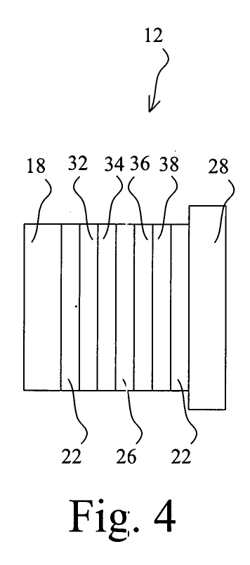

Refer to FIG. 4 for a further embodiment of the present invention. In this embodiment, the foamed layer 20 has a first foamed layer 32 and a second foamed layer 34, and the magnetic layer 24 has a first magnetic layer 36 and a second magnetic layer 38.

In this embodiment, the UHF RFID tag 12 of the present invention comprises: a tag 18, a first foamed layer 32, a second foamed layer 34, a first magnetic layer 36 and a second magnetic layer 38. The first foamed layer 32 and the second foamed layer 34 are arranged in between the tag 18 and the magnetic layer 24. The first foamed layer 32 and the second foamed layer 34 are joined together with a glue 26. The first magnetic layer 36 and the second magnetic layer 38 are also joined together with the glue 26. The tag 18 is joined to the first foamed layer 32 with a double-sided adhesive tape 22. The second foamed layer 34 is joined to the first magnetic layer 36 with the glue 26. The second magnetic layer 38 is joined to a metallic/non-metallic layer 28 with the double-sided adhesive tape 22.

In this embodiment, both the first foamed layer 32 and the second foamed layer 34 are made of a foamed polymeric material. The first foamed layer 32 has a permittivity of 1-1.1 or 1-1.2, and the second foamed layer 34 has a permittivity of 1-1.5. The first foamed layer 32 has a density of 10-50 kg/m³, and the second foamed layer 34 has a density of 50-100 kg/m³. The polymeric material is selected from the group consisting of a foamed PE/EVA (Polyethylene/Ethylene Vinyl Acetate) board, a foamed CR/EPDM/NBR (Chloroprene Rubber/Ethylene Propylene Diene Monomer/Nitrile Butadiene Rubber) board, a foamed PS (Polystyrene) board, a foamed rubberplastic board, a foamed conductive board, and a foamed anti-electrostatic board. The polymeric material may also be a combination of the abovementioned materials.

In this embodiment, each of the first magnetic layer 36 and the second magnetic layer 38 consists of a magnetic powder and a rubber/plastic material. The first magnetic layer 36 has a magnetic permeability of 2-5, and the second magnetic layer 38 has a magnetic permeability of 6-10. The magnetic powder has a weight percent of 65-95%, and the rubber/plastic material has a weight percent of 5-35%. The magnetic powder is made of an iron powder, a cobalt powder, a nickel powder or a powder of an alloy containing the abovementioned metals. The magnetic layer has a thickness of 0.1-3 mm. In the present invention, the particles of the magnetic powder have a shape of a platelet, a lens or a spheroid. In this embodiment, the particles of the magnetic powder have a shape of a platelet. The platelet particles of the magnetic powder have a diameter of 5-35 μm and a thickness of 0.05-0.25 μm.

In a still further embodiment, the foamed layer 20 has a gradient density. In other words, the density varies from low to high. The low-density side of the foamed layer 20 is joined to the tag 18, and the high-density side is joined to the magnetic layer 24. Similarly, the magnetic layer 24 may also have a gradient magnetic powder density. In other words, the density of the magnetic powder varies from low to high. The low-density side of the magnetic layer 24 is joined to the foamed layer 20, and the high-density side is joined to the metallic/non-metallic layer 28.

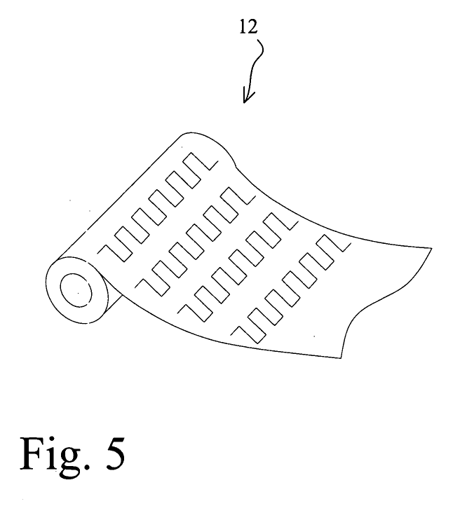

Refer to FIG. 5 a diagram schematically showing UHF RFID tags according to the present invention. In an ideal test environment, the present invention can restore 75-95% the original read distance. In a common test environment, the present invention can still restore the read distance appropriately. In the present invention, a low-cost foamed material is used to modify the thickness of magnetic powder material, whereby the fabrication cost of tags is greatly reduced, and the applications of RFID technology can be further popularized.

The embodiments described above are only to exemplify the present invention but not to limit the scope of the present invention. Therefore, any equivalent modification or variation according to the shapes, structures, characteristics and spirit of the present invention is to be also included within the scope of the present invention.

What is claimed is:

1. A UHF (Ultra High Frequency) RFID (Radio Frequency Identification) tag comprising:
a tag;
a foamed layer contacting said tag, made of a polymeric material, and having a density of 10-100 kg/m³;
a magnetic layer contacting another side of said foamed layer, made of a magnetic powder and a rubber or plastic material, wherein said magnetic powder has a weight percent of 65-95%, and said rubber or plastic material has a weight percent of 5-35%, and wherein said magnetic layer has a thickness of 0.1-3 mm, and wherein particles of said magnetic powder have a shape of a platelet, a lens or a spheroid.

2. The UHF RFID tag according to claim 1, wherein said foamed layer is joined to said magnetic layer with a glue.

3. The UHF RFID tag according to claim 1, wherein said tag is joined to said foamed layer with a double-sided adhesive tape.

4. The UHF RFID tag according to claim 1 further comprising a metallic or non-metallic layer joined to another side of said magnetic layer with a double-sided adhesive tape.

5. The UHF RFID tag according to claim 1, wherein said polymeric material is selected from a group consisting of a foamed PE/EVA (Polyethylene/Ethylene Vinyl Acetate) board, a foamed CR/EPDM/NBR (Chloroprene Rubber/Ethylene Propylene Diene Monomer/Nitrile Butadiene Rubber) board, a foamed PS (Polystyrene) board, a foamed rubberplastic board, a foamed conductive board, a foamed anti-electrostatic board, and a combination of said boards.

6. The UHF RFID tag according to claim 1, wherein said foamed layer has a permittivity of 1-1.5.

7. The UHF RFID tag according to claim 1, wherein said magnetic layer has a magnetic permeability of 2-10.

8. The UHF RFID tag according to claim 1, wherein said magnetic layer contains an iron powder, a cobalt powder, a nickel powder or a powder of an alloy containing iron, cobalt, and/or nickel.

9. The UHF RFID tag according to claim 1, wherein particles of said magnetic powder have a shape of a platelet, and platelet particles of said magnetic powder have a diameter of 5-35 μm and a thickness of 0.05-0.25 μm.

10. The UHF RFID tag according to claim 8, wherein particles of said magnetic powder have a shape of a platelet, and platelet particles of said magnetic powder have a diameter of 5-35 μm and a thickness of 0.05-0.25 μm.

11. The UHF RFID tag according to claim 1, wherein said foamed layer further comprises:
a first foamed layer has a density of 10-50 kg/m³ and a thickness of 1-10 mm, and
a second foamed layer has density of 15-75 kg/m³ and a thickness of 1-10 mm;
said first foamed layer and said second foamed layer are joined together with a glue; said second foamed layer is joined to said magnetic layer with a glue.

12. The UHF RFID tag according to claim 4, wherein said foamed layer further comprises:
a first foamed layer having a density of 10-50 kg/m³ and a thickness of 1-10 mm, and
a second foamed layer having a density of 15-75 kg/m³ and a thickness of 1-10 mm;
said first foamed layer and said second foamed layer are joined together with a glue; said second foamed layer is joined to said magnetic layer with a glue.

13. The UHF RFID tag according to claim 11, wherein said first foamed layer has a permittivity of 1-1.1 or 1-1.2.

14. The UHF RFID tag according to claim 12, wherein said first foamed layer has a permittivity of 1-1.1 or 1-1.2.

15. The UHF RFID tag according to claim 11, wherein said second foamed layer has a permittivity of 1-1.5.

16. The UHF RFID tag according to claim 12, wherein said second foamed layer has a permittivity of 1-1.5.

17. The UHF RFID tag according to claim 1, wherein said foamed layer has a gradient density; a low-density side of said foamed layer is joined to said tag, and a high-density side of said foamed layer is joined to said magnetic layer.

18. The UHF RFID tag according to claim 1, wherein said magnetic layer has a gradient magnetic powder density; a low-density side of said magnetic layer is joined to said foamed layer.

19. The UHF RFID tag according to claim 17, wherein said magnetic layer has a gradient magnetic powder density; a low-density side of said magnetic layer is joined to said foamed layer.

20. The UHF RFID tag according to claim 1 further comprising a metallic or non-metallic layer joined to a high-density side of said magnetic layer with a double-sided adhesive tape.

21. The UHF RFID tag according to claim 17 further comprising a metallic or non-metallic layer joined to a high-density side of said magnetic layer with a double-sided adhesive tape.

22. The UHF RFID tag according to claim 1, wherein said magnetic layer further comprises:
a first magnetic layer having a magnetic permeability of 2-5, and
a second magnetic layer having a magnetic permeability of 6-10;
said first magnetic layer and said second magnetic layer are joined together with a glue; said first magnetic layer contacts said foamed layer; a total thickness of said first magnetic layer and said second magnetic layer is 1-10 mm.

23. The UHF RFID tag according to claim 4, wherein said magnetic layer further comprises:
a first magnetic layer having a magnetic permeability of 2-5, and
a second magnetic layer having a magnetic permeability of 6-10;
said first magnetic layer and said second magnetic layer are joined together with a glue; said first magnetic layer contacts said foamed layer; a total thickness of said first magnetic layer and said second magnetic layer is 1-10 mm.

24. The UHF RFID tag according to claim 10, wherein said magnetic layer further comprises:
a first magnetic layer having a magnetic permeability of 2-5, and
a second magnetic layer having a magnetic permeability of 6-10;
said first magnetic layer and said second magnetic layer are joined together with a glue; said first magnetic layer contacts said foamed layer; a total thickness of said first magnetic layer and said second magnetic layer is 1-10 mm.

25. The UHF RFID tag according to claim 11, wherein said magnetic layer further comprises:
a first magnetic layer having a magnetic permeability of 2-5, and
a second magnetic layer having a magnetic permeability of 6-10;
said first magnetic layer and said second magnetic layer are joined together with a glue; said first magnetic layer contacts said foamed layer; a total thickness of said first magnetic layer and said second magnetic layer is 1-10 mm.
